(19) United States
(12) Patent Application Publication
(10) Pub. No.: US 2004/0010720 A1
(43) Pub. Date: Jan. 15, 2004

(54) System and method for remote supervision and authentication of user activities at communication network workstations

(76) Inventors: Romi Singh, Monmouth Junction, NJ (US); Koushik Roy, East Windsor, NJ (US); Emad A. Shanad, Monmouth Junction, NJ (US)

Correspondence Address: Edward Etkin, Esq., Suite 3C, 4804 Bedford Avenue, Brooklyn, NY, 11235, US

(21) Appl. No.: 10/620,004

(22) Filed: Jul. 14, 2003

Related U.S. Application Data
(60) Provisional application No. 60/395,584, filed on Jul. 12, 2002.

(51) Int. Cl. G06F 11/30; H04L 9/32

(52) U.S. Cl. 713/201; 709/224

(57) ABSTRACT

The inventive system provides real-time audio-visual monitoring, supervision, and/or controlling of activities of remote users and of the users' workstations via a network by a human supervisor using a supervisor workstation for the purpose of verifiable skill testing (i.e., for standardized tests) with real time user activity monitoring, and in alternate embodiments of the present invention for: remote instruction, remote interviewing, remote system control and tuning, remote customer service and technical support. The system delivers the above functionality via one or more user workstations with multimedia and communication capabilities configures for bi-directional communication with a similarly equipped supervisor workstation over a communication. Key novel features of the inventive system include but are not limited to: recording and storing an audio/video record of one or more user sessions as authentication for monitored user activities (this enables a record of test-taking, on-line interview, etc), dynamic assignment of supervisors depending on user activity monitoring needs and supervisor availability (including suspension of system and user activity if a supervisor is not available), and identity verification of the user(s). The inventive system includes other features and embodiments such as adaptive dynamic testing and improved audio-visual signal transmission from the user workstations. Finally, novel and optimized front end interfaces are provided for utilization of the inventive system by supervisors and users.

### CROSS REFERENCE TO RELATED APPLICATIONS

The present patent application claims priority from the commonly assigned U.S. provisional patent application S/No. 60/395,584 entitled “SYSTEM AND METHOD FOR REMOTE SUPERVISION AND AUTHENTICATION OF USER ACTIVITIES AT COMMUNICATION NETWORK WORKSTATIONS” filed Jul. 12, 2002.

### FIELD OF THE INVENTION

The present invention relates generally to data processing systems for providing services over a communication network and more particularly to a data processing and communication system for monitoring, supervising and authenticating remote user activities over a communication network.

### BACKGROUND OF THE INVENTION

In the past twenty years, computers have taken the world by storm. While multimedia communication systems, such as satellite-based video-conferencing systems, have been developed some time ago, Internet- and network-based systems for remote workstation control and network-based multimedia communications have only come into use in recent years.

There are a number of challenges that many hoped would be solved by network-based multimedia and data communication systems. These challenges included remote exam administration, remote technical/customer support, as well as remote skill training. The advent of increased computing power and availability of high-bandwidth connections have resulted in a number of applications for network based multimedia communication systems that attempted to address the above-described challenges. These applications include:

Remote delivery and administration of standardized tests via an administrator sever connected to test-taking workstations over a network;

Delivery of remote training sessions including multimedia content to multiple users over a network; and

Videoconferencing with simultaneous task collaboration by multiple users utilizing workgroup software over a communication network.

Numerous patents have been issued disclosing a plethora of technologies that implement the above applications through various techniques. However, prior art solutions have been tailored for very specific narrow tasks and suffer from limited flexibility and other crucial drawbacks. Typically prior art multimedia communication systems are configured to perform specific tasks and cannot be readily modified or adapted for similar but different applications. For example, while remote training systems may transmit an audio/visual signal from the instructor to the students, the instructor cannot monitor the students, which would be advantageous for remote exam delivery. Most importantly, the various prior art systems do not keep any record of user sessions and of administrator-user communications for authentication of user activities. This a particularly problematic flaw with numerous applications such as remote examinations, and even customer support. Furthermore, in prior art systems where an administrator interacts with one or more remote users, the administrator is typically limited to transmitting information to user workstations and has limited control over a user's activities at their workstation. In addition to limited communication functionality, prior art remote exam delivery systems do not provide truly adaptive exam configuration, instead relying on scripted question selection algorithms rather than on specific test-taker parameters. Finally, all previously known solutions relying on multimedia communication systems suffer from a significant drawback that restricts flow of audio-visual data from user workstations to a central workstation over a network. Thus, most prior art systems simply rely on streaming audio-visual data to the user workstations.

It would thus be desirable to provide a multimedia communication system capable of advantageously supporting multiple applications including, but not limited to: verifiable on-line skill testing with real-time user activity monitoring and remote user identity verification, remote training, remote interviewing, remote system technical support, and remote customer service. It would also be desirable to provide a system that enables real-time audio-visual monitoring, supervision, and/or controlling of activities of remote users and of the users' workstations via a network by one or more human supervisors, each using a supervisor workstation. It would further be desirable to provide a system capable of recording and storing an audio/video record of one or more user sessions as authentication for monitored user activities. It would additionally be desirable to provide a system dynamically configuring an adaptive testing environment for advantageously accurate and efficient testing of user skill sets and proficiency levels. It would also be desirable to provide a system capable of dynamically and readily transmitting real-time audio-visual data from one or more user workstations to the corresponding supervisor workstation.

### BRIEF DESCRIPTION OF THE DRAWINGS

In the drawings, wherein like reference characters denote corresponding or similar elements throughout the various figures:

FIG. 1 is a block diagram showing exemplary components of a first embodiment of the inventive multimedia communication and monitoring system;

FIG. 2 is a block diagram of an exemplary implementation of a user workstation of the communication and monitoring system of FIG. 1;

FIG. 3 is a block diagram of an exemplary implementation of a supervisor workstation of the communication and monitoring system of FIG. 1;

FIG. 4 is a block diagram of an exemplary implementation of a server of the communication and monitoring system of FIG. 1;

FIG. 5 is a block diagram showing exemplary components of a second embodiment of the inventive communication and monitoring system;

FIG. 6 is a flow process diagram showing an inventive activity monitoring program process executed by the communication and monitoring system of FIG. 1 or 5;

FIG. 7 is a flow process diagram showing a preparation program module utilized by the inventive program process of FIG. 6;

FIG. 8 is a flow process diagram showing a monitoring program module utilized by the inventive program process of FIG. 6;

FIG. 9 is a diagram of a first embodiment of an exemplary front-end interface for a supervisor workstation utilized in accordance with the inventive communication and monitoring system of FIG. 1 or 5;

FIG. 10 is a diagram of a second embodiment of an exemplary front-end interface for a supervisor workstation utilized in accordance with the inventive communication and monitoring system of FIG. 1 or 5;

FIG. 11 is a flow process diagram showing an inventive program process executed by a communication and instruction system that is an alternate embodiment of the communication and monitoring system of FIG. 1 or 5;

FIG. 12 is a diagram of a second embodiment of an exemplary front-end interface for an instructor workstation utilized by an instructor in accordance with execution of the inventive program process of FIG. 11; and

FIG. 13 is a diagram of a an exemplary front-end interface for a user workstation utilized by a student in accordance with execution of the inventive program process of FIG. 11.

### SUMMARY OF THE INVENTION

The present invention is directed to a novel multimedia monitoring and communication system for real-time audio-visual monitoring, supervision, and/or controlling of activities of remote users and of the users' workstations via a network by a human supervisor using a supervisor workstation for the purpose of verifiable skill testing (i.e., for standardized tests) with real time user activity monitoring, and in alternate embodiments of the present invention for: remote instruction, remote interviewing, remote system control and tuning, remote customer service and technical support. The system delivers the above functionality via one or more user workstations with multimedia and communication capabilities (e.g. computers supplied with cameras, speakers and microphones) configured for bidirectional communication with a similarly equipped supervisor workstation over a network (LAN, WAN, Internet, etc.). Key novel features of the inventive system include but are not limited to: recording and storing an audio/video record of one or more user sessions as authentication for monitored user activities (this enables a record of test-taking, on-line interview, etc), dynamic assignment of supervisors depending on user activity monitoring needs and supervisor availability (including suspension of system and user activity if a supervisor is not available), and identity verification of the user(s). The inventive system includes other features and embodiments such as adaptive dynamic testing and improved audio-visual signal transmission from the user workstations.

The workstations used by the users and supervisors are connected to the network and each include a computer (such as a personal computer) with a display, an input device (i.e. keyboard, mouse), a network communication device, an audio input device (e.g. microphone), an audio output device (e.g. speakers, headphones), and a video acquisition device mounted at the workstation so as to capture all user activities at the user workstation and surrounding predefined “working area”. An optional biometric device (such as a fingerprint scanner or a facial recognition unit) may be connected to the user workstation to provide an additional level of user identity verification.

A server may be included in the system for storing audio-visual and data records of user sessions at user workstations recorded in connection with a variety of predetermined user activities at the user workstation and for controlling and monitoring the communication connections between a supervisor workstation and user workstations. Alternately, audio-visual and data records may be stored at one or more of the supervisor workstations. The workstations and the server may utilize one or more operating systems such as Windows™, UNIX, Linux, or mainframe systems and support third party software (i.e. database and communication software). The various hardware and software components of the inventive system may be selected from commonly available computer systems as a matter of design choice without departing from the spirit of the invention.

It should however be noted that remote user task monitoring is just one example of possible usage of the inventive system. Other user activities to be monitored and controlled are envisioned and the inventive system may be readily adapted to such applications without departing from the spirit of the invention. These alternate embodiments of the present invention include, a remote instruction system, a remote interviewing system and a remote technical support/IS administration system.

Advantageously, various embodiment of the inventive system also include novel modular front end interfaces for the supervisors/instructors and for the users (in case of the remote instruction embodiment of the novel system) optimized for the functionality of the system of the present invention.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### DETAILED DESCRIPTION OF PREFERRED EMBODIMENTS

The system and method of the present invention remedy the disadvantages of previously known multimedia communication system-based applications. In brief summary, the inventive system provides identity verification, real-time audio-visual monitoring, supervision, and/or controlling of activities of remote users and of the users' workstations via a communication network by one or more human supervisors, each using a supervisor workstation. In accordance with the present invention, the user activities at the workstation are recorded and stored for future authentication. The inventive system can incorporate numerous other features and embodiments, including, but not limited to, adaptive dynamic testing and improved audio-visual signal transmission from the user workstations. Furthermore, the inventive system can be readily modified and configured by one skilled in the art to perform other functions, such as providing training, facilitating remote technical support, remote interviewing, and providing a video dating service

In essence, the system and method of the present invention provide for real-time remote collaboration between one or more supervisors and one or more users via a communication network, such as the Internet. The present invention establishes a virtual presence between geographically distributed remote users and supervisors that allow for real-time interactive monitoring and controlling of user workstations and user activities at the workstations by one or more supervisors. Furthermore, monitored audio-visual data is stored and made available to any concerned parties (for example a testing administration authority) as a proof of authenticity and proper performance of the monitored activities. Optionally, each user's identity may be verified, and the verification stored, for example via a biometric identity verification system that may be placed at each user's workstation.

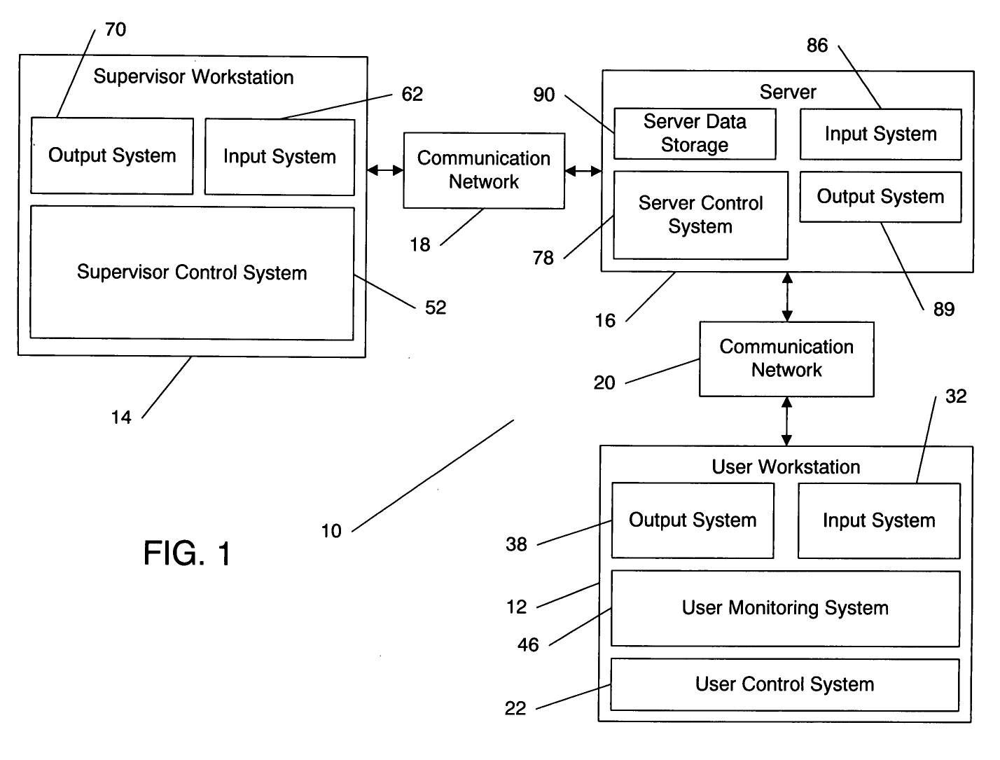

Referring now to FIGS. 1 through 4, a first embodiment of an inventive communication and monitoring system 10 is shown. The system 10 includes three primary components: a user workstation 12, a supervisor workstation 14, and a server 16. Preferably these system 10 components are computer systems capable of executing application programs. The workstations 12, 14 and the server 16 may utilize one or more operating systems such as Windows, UNIX, Linux, or mainframe systems and support third party software (i.e. database and communication software). The various hardware and software component elements of the inventive system 10 that are described below in connection with FIGS. 1 through 4, may be selected as a matter of design choice without departing from the spirit of the invention.

The supervisor workstation 14 is preferably connected to the server 16 via a communication network 18, while the user workstation 12 is preferably connected to the server 16 via a communication network 20. The communication networks 18, 20 may be any communication network for transmitting program and audio-visual data—this includes, but is not limited to one or more of the following: Internet, local area network (LAN), wide area network (WAN), Intranet, dial-up network, and wireless network. The communication networks 18, 20 may each be a different type of network—for example the communication network 18 may be a LAN, while the communication network 20 may be the Internet. Alternately, both communication networks 18, 20 may be part of the same communication network (for example, the Internet). Optionally, the user workstation 12 may be directly connected to the supervisor workstation 14 via the communication network 18 or 20, with the server 16 monitoring and controlling that connection.

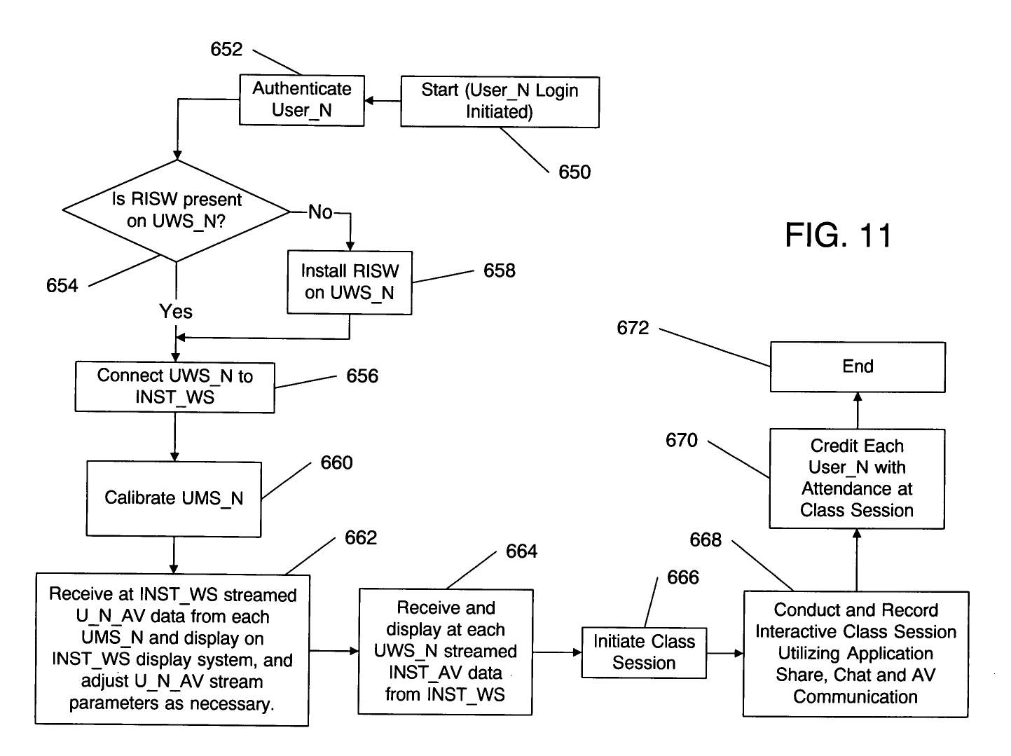

It should be noted that the term “supervisor” is used to describe, by way of example, the role of one or more individuals that oversee and administrate various system 10 functions from one or more control workstations (i.e. supervisor workstations 14). In other embodiments of the present invention, for example a remote instruction embodiment described below in connection with FIGS. 11 to 13, an instructor assumes the supervisor role. Finally, while reference is made to capturing, transmitting, recording, and storing audio-visual data, it should be understood to one skilled in the art that, optionally, only video data may be captured, transmitted, recorded, and stored without departing from the spirit of the invention.

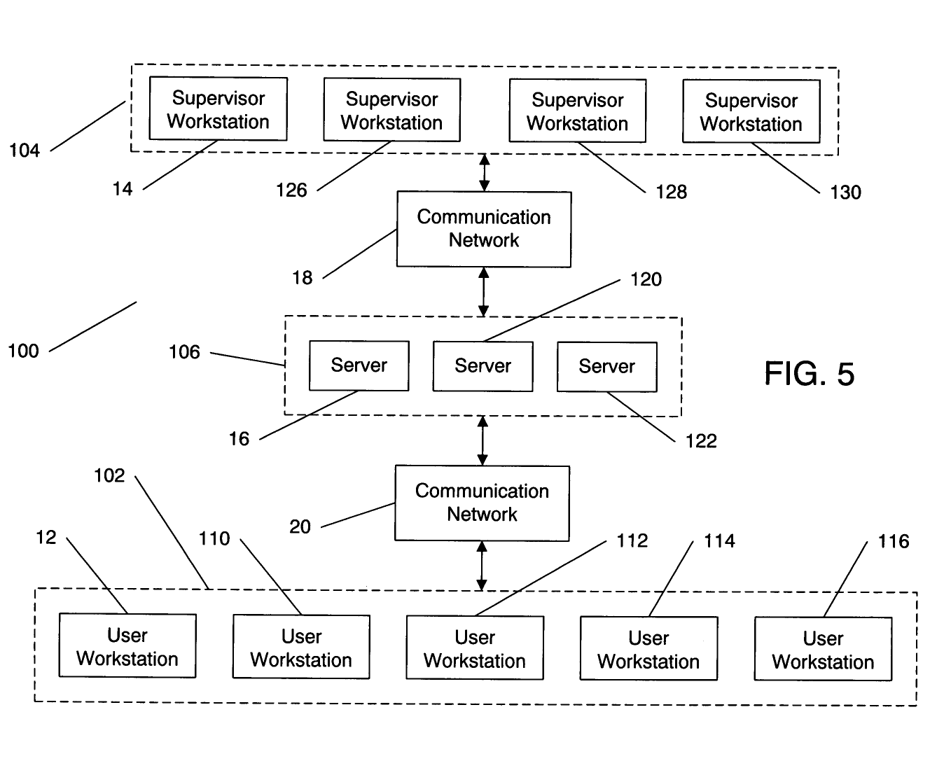

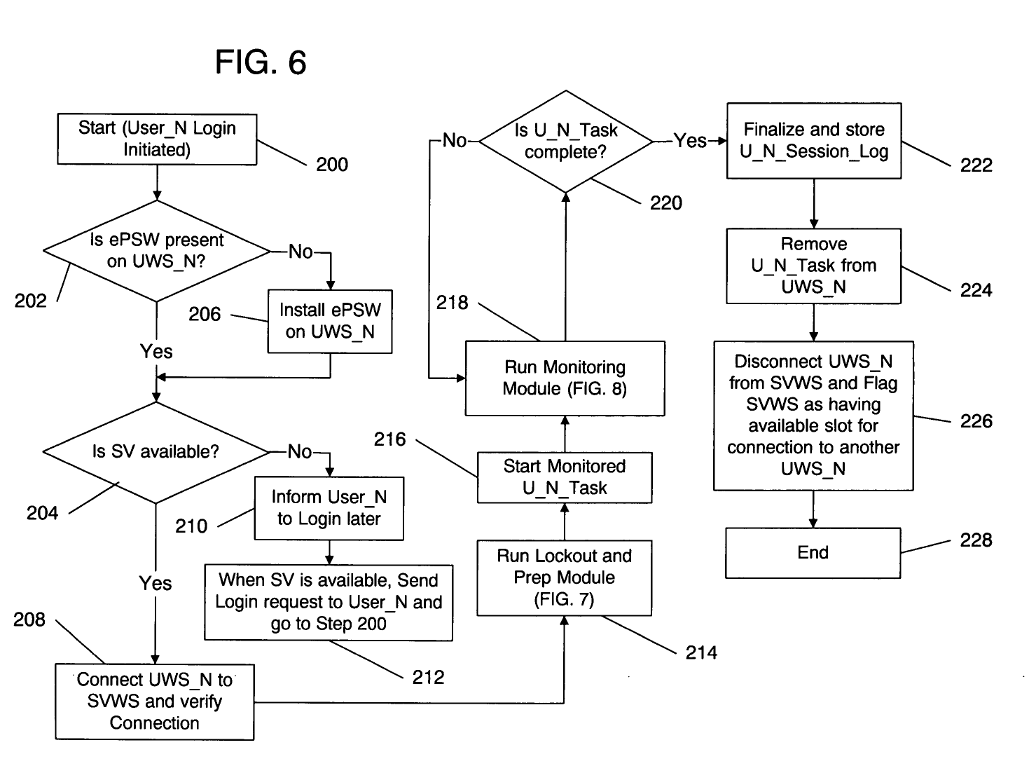

It should be noted that only one of each system 10 components (user workstation 12, supervisor workstation 14, and server 16) are shown in FIG. 1 by way of simplified example. In actual implementation, the system 10 can be implemented as may include multiple units of each component (shown as system 100 n FIG. 5). A main program and associated program modules (described below in connection with FIGS. 6 through 8), that controls operation of the inventive system 10 (or inventive system 100 of FIG. 5), may be executed by one or more components 12, 14, 16 of the system 10 as a matter of design choice, without departing from the spirit of the invention. Preferably, different elements of the main program may be each executed by individual sub-systems of the components 12, 14, 16.

In essence, the system 10 components 12, 14, and 16 interact with one another under control of the main program to: (1) enable the user to perform a predefined task at the user workstation 12, (2) enable the supervisor to use the supervisor workstation 14 to monitor user's task performance and user activities at the user workstation 12, and (3) enable the server 16 to mediate and control the connection between the user workstation 12 and the server workstation 14, and record and store data representative of the user's session (i.e. user's task performance and user activities at the user workstation 12). The recorded user sessions then serve as verification of monitored performance and activities.

Before describing the operation of the main program of FIGS. 6 to 8, it would be helpful to describe the system 10 components in more detail. The user workstation 12 may be any computer system (such as a personal computer), located at a predefined “working area”, that includes the following interconnected systems: a user control system 22 for controlling the various components of the user workstation 12, executing program instructions, storing data, etc., an input system 32 for receiving instructions, data and, optionally, verification information from the user, an output system 38 for conveying information to the user, and a user monitoring system 46 for audio-visual (AV) capture of all user activities at the user workstation 12 and surrounding the predefined working area.

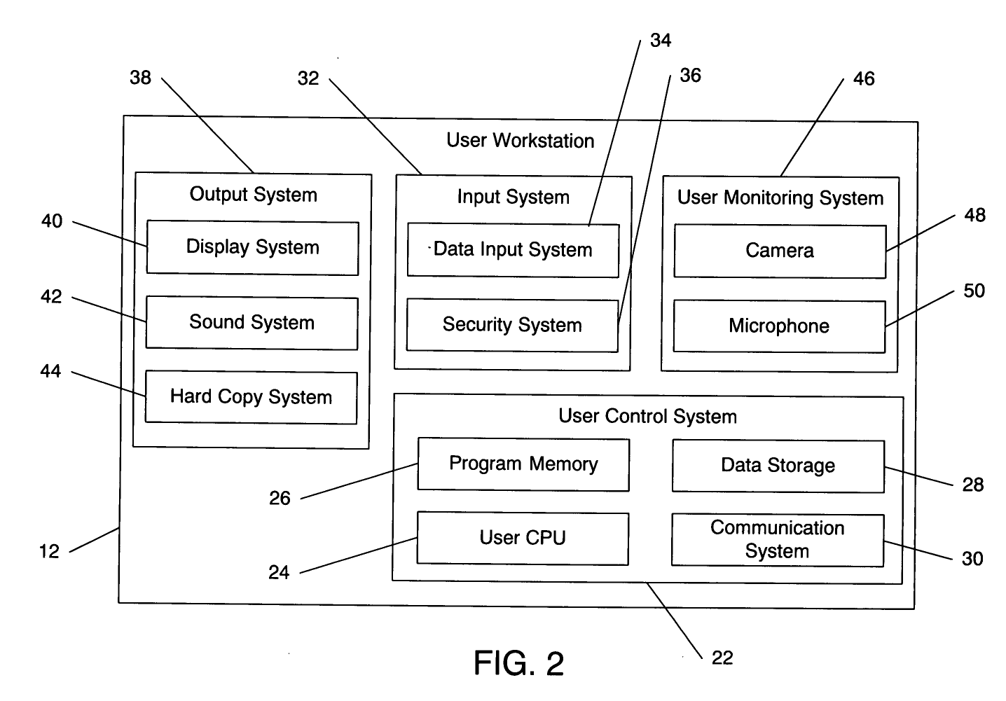

Referring now to FIG. 2, the user workstation 12 is shown in greater detail. The user control system 22 is preferably a main computer unit that may include, but is not limited to:

a user CPU 24 and associated hardware for running an operating system, for executing application programs (including for example, a portion of the system 10 main program), and otherwise controlling operation of all components of the user workstation 12;

a program memory 26, such as random access memory (RAM) or equivalent, for temporarily storing data, program instructions and variables during the execution of application programs by the user CPU 24;

a data storage 28, such as flash memory, a hard disk drive, or equivalent for long term storage of data and application programs; and

a communication system 30, such as a modem, a network interface device or equivalent, for transmitting to, and receiving data from, the supervisor workstation 14 and the server 16 through the communication networks 18, 20 utilizing one or more telecommunication links such as a standard telephone line, a local network line, a DSL or Cable line, a high speed data transmission such as a T1 or T3 line, or a wireless telecommunication (i.e. a cellular or radio) link.

The input system 32 preferably includes a data input system 34 that includes at least one of the following input devices: a keyboard, a selection device (i.e. mouse, trackball, or touchpad), and a voice recognition device with speech to text capabilities. Optionally, the input system 32 may include a security system 36 for receiving additional identity verification data from the user. For example, it may be a biometric device such as a fingerprint scanner, face recognition device, or a retinal scanner.

The output system 38 preferably includes a display system 40, such as a monitor, an optional sound system, 42 such as speakers or headphones, and an optional hard copy system 44, such as a printer.

The user monitoring system 46 preferably includes a camera 48 (or similar video acquisition device) mounted at the user workstation 12 so as to capture all user activities at the user workstation 12 and the surrounding predefined working area. Preferably, the camera 48 is capable of motion such that a supervisor using the supervisor workstation 14, can move the camera 48 to obtain a desired view of the user and of the working area around the user workstation 12. The user monitoring system 46 may also include a microphone 50, or other equivalent audio acquisition device, for acquiring audio data from the user and from the user's environment. Thus, the user monitoring system 46, utilizing the camera 48 and the microphone 50, is capable of acquiring live AV information representative of user's activities in the working area. This live AV information can then be readily transmitted (i.e. streamed) to the server 16 and the supervisor workstation 14 using the communication system 30.

The supervisor workstation 14 may be any computer system (such as a personal computer), that includes the following interconnected systems: a supervisor control system 52 for controlling the various components of the supervisor workstation 14, executing program instructions, storing data, etc., an input system 62 for receiving instructions, data and, optionally, verification information from the supervisor, and an output system 70 for conveying information to the supervisor.

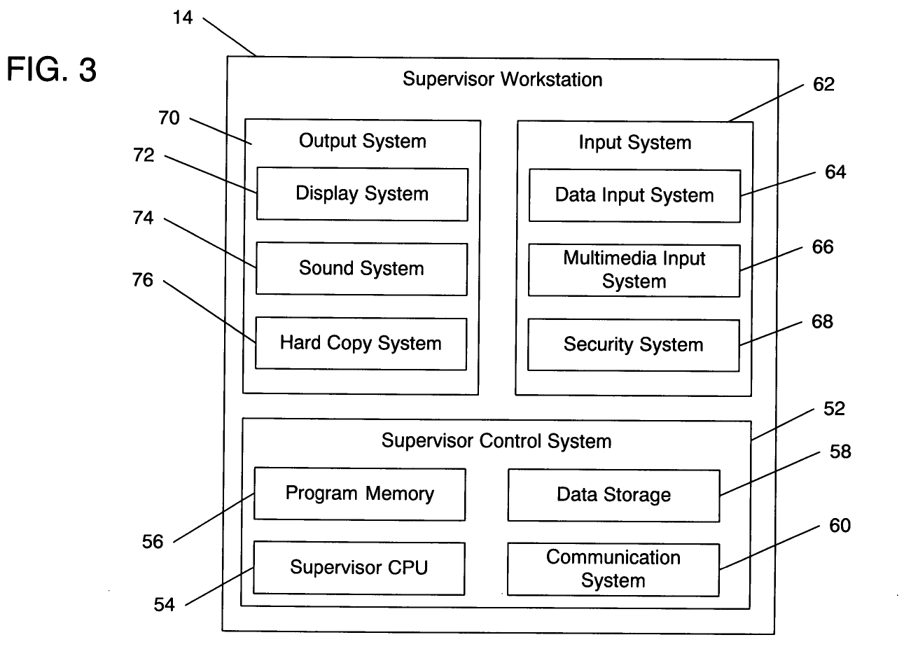

Referring now to FIG. 3, the supervisor workstation 14 is shown in greater detail. The supervisor control system 52 is preferably a main computer unit that may include, but is not limited to:

a supervisor CPU 54 and associated hardware for running an operating system, for executing application programs (including for example, a portion of the system 10 main program), and otherwise controlling operation of all components of the supervisor workstation 14;

a program memory 56, such as random access memory (RAM) or equivalent, for temporarily storing data, program instructions and variables during the execution of application programs by the supervisor CPU 54;

a data storage 58, such as flash memory, a hard disk drive, or equivalent for long term storage of data and application programs; and

a communication system 60, such as a modem, a network interface device or equivalent, for transmitting to, and receiving data from, the user workstation 12 and the server 16 through the communication networks 18, 20 utilizing one or more telecommunication links such as a standard telephone line, a local network line, a DSL or Cable line, a high speed data transmission such as a T1 or T3 line, or a wireless telecommunication (i.e. a cellular or radio) link.

The input system 62 preferably includes a data input system 64 that includes at least one of the following input devices: a keyboard, a selection device (i.e. mouse, trackball, or touchpad), and a voice recognition device with speech to text capabilities. Optionally, the input system 62 may include a security system 68 for receiving identity verification data from the supervisor to authenticate the supervisor's authority to utilize the supervisor workstation 14. For example, it may be a biometric device such as a fingerprint scanner, face recognition device, or a retinal scanner. An optional multimedia input system 66 that may include a camera and a microphone positioned to acquire AV data representative of the supervisor utilizing the supervisor workstation 14. The supervisor AV data may be optionally recorded and stored at the supervisor workstation 14 and/or at the server 16 and may be used to verify supervisor's attendance at the monitoring session, for training purposes of future supervisors, or for other purposes. Alternately, in certain alternate embodiments of the system 10 main program, the supervisor AV data may be transmitted to the user workstation 12 (for example, as described below in connection with FIGS. 11 through 13).

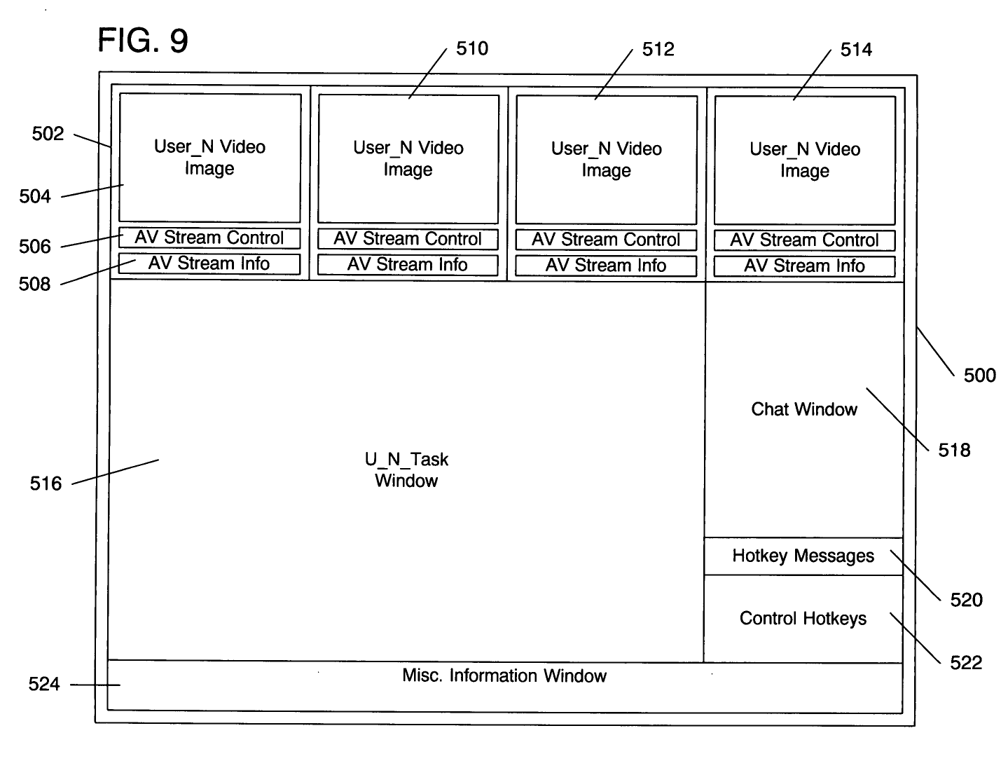

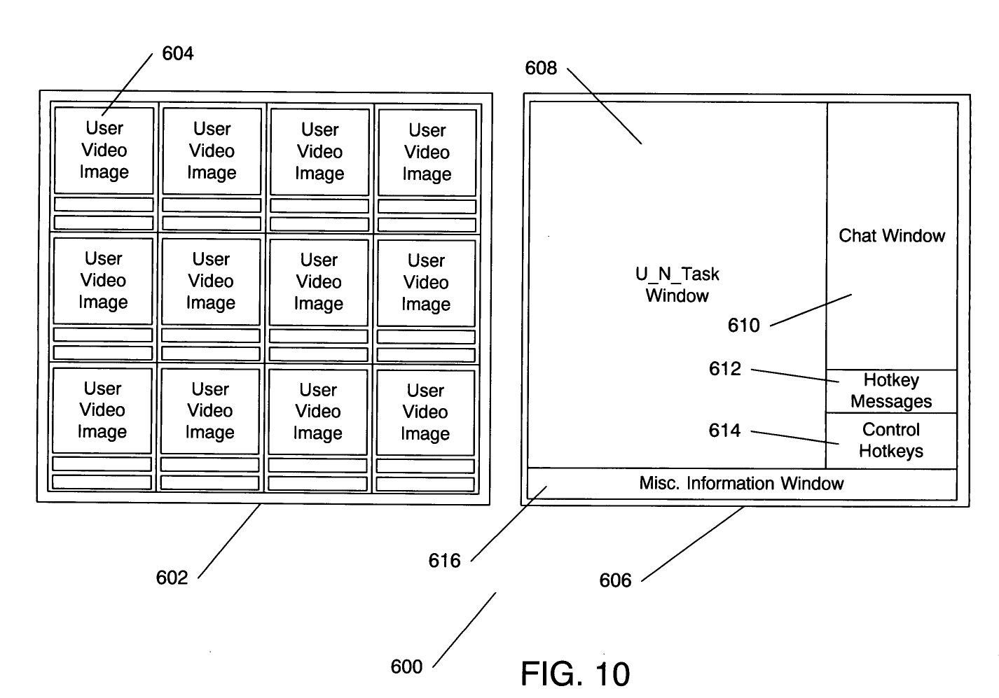

The output system 70 preferably includes a display system 72, such as a monitor or a group of display monitors for displaying video information received from the user workstation 12 as well as other information routed to the supervisor workstation 14 by the system 10 main program (i.e. session data, other information from the user workstation 12, etc.). While a single display monitor may be utilized to display all the necessary information (as described below in connection with FIG. 9), preferably, the display system 72 includes multiple display monitors for displaying information received by the supervisor workstation 14 (as described below in connection with FIG. 10). The output system 70 also includes a sound system 74 such as speakers or headphones for playback of audio information received from the user workstation 12, and an optional hard copy system 76, such as a printer.

The server 16 may be any computer system preferably optimized for server functionality, that includes the following interconnected systems: a server control system 78 for controlling the various components of the server 16, executing program instructions, storing data, etc., an input system 86 for receiving instructions, data and, optionally, verification information from a server administrator, an output system 89 for conveying information to the server administrator, and a server data storage system 90 for long-term storage of application data and user session data.

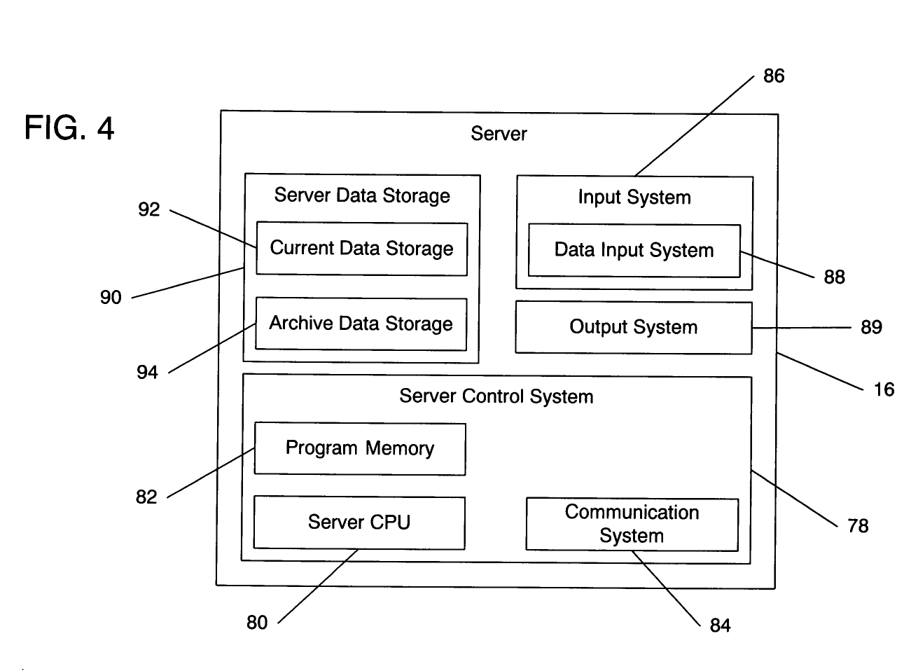

Referring now to FIG. 4, the server 16 is shown in greater detail. The server control system 78 is preferably a main computer unit (preferably optimized for server functionality, such as multithreading) that may include, but is not limited to:

a server CPU 80 and associated hardware for running a server operating system, for executing application programs (including for example, a portion of the system 10 main program), and otherwise controlling operation of all components of the server 16;

a program memory 82, such as random access memory (RAM) or equivalent, for temporarily storing data, program instructions and variables during the execution of application programs by the server CPU 80;

a communication system 84, such as a modem, a network interface device or equivalent, for transmitting to, and receiving data from, the user workstation 12 and the supervisor workstation 14 through the communication networks 18, 20 utilizing one or more telecommunication links such as a standard telephone line, a local network line, a DSL or Cable line, a high speed data transmission such as a T1 or T3 line, or a wireless telecommunication (i.e. a cellular or radio) link.

The input system 86 preferably includes a data input system 88 that includes at least one of the following input devices: a keyboard, a selection device (i.e. mouse, trackball, or touchpad), and a voice recognition device with speech to text capabilities. The output system 89 preferably includes at least a display system, such as a monitor, an optional sound system such as speakers or headphones, and an optional hard copy system, such as a printer.

The server data storage 90 preferably includes a current data storage 92, such as flash memory, a hard disk drive, or equivalent, for storage of data (including user session data) and application programs, and an optional archive data storage 94, such as a hard drive, optical drive, tape drive or equivalent, for long-term storage of prior user session records in a backup or other format. Use of the archive data storage 94 is advantageous in case verification of particular user's session activities may become necessary long after that user's session is completed.

In an alternate embodiment of the present invention, the server 16 may be eliminated and its functions assumed by the corresponding components of the supervisor's workstation 14, in which case, the user workstation 12 would be connected directly to the supervisor workstation 14 via the communication system 18 or 20.

Referring now to FIG. 5, an exemplary implementation of the system 10 utilizing multiple user and supervisor workstations and servers is shown as a system 100. The system 100 includes: a user workstation set 102 comprised of multiple user workstations 12 and 110 to 116 (each corresponding in configuration to the user workstation 12), each of which may be in separate geographic location; a supervisor workstation set 104 comprised of multiple supervisor workstations 14 and 126 to 130 (each corresponding in configuration to the supervisor workstation 14), each of which may be in separate geographic location; and a server set 106 comprised of multiple servers 16, and 120 to 122 (each corresponding in configuration to the server 16), each of which likewise may be in a separate geographic location. Essentially, the system 100 is an extension of the simplest configuration (system 10) of the present invention.

In a real-world application, the true advantage of the inventive system. 100 becomes readily apparent with its capability to operate with its various components in different geographic locations. This arrangement, for example, enables electronic proctoring (i.e. eProctoring) of exam-taking by multiple users in different parts of the country (or the world) by one or more supervisors located in yet a different geographic location without the enormous expense and inconvenience of a formal testing center, dedicated testing equipment, and dedicated testing and proctoring staff. Other advantageous applications of the inventive system 100, for example for remote instruction should likewise be apparent.

The specific number of the user workstations in the user workstation set 102, the specific number of the supervisor workstations in the supervisor workstation set 104, and the specific number of servers in the server set 106 may be selected as a matter of design choice without departing from the spirit of the invention. For example, the user workstation set 102 can include one hundred user workstations, the server set 104 may include two servers, and the supervisor workstation set 104 may include five supervisor workstations. Most importantly, these various quantities are dynamic and may continually change as users log on to and log off from the system 100, and as supervisors enter and leave the system.

It should also be noted that the system 100 is capable of running multiple instances of the main program, each dedicated to administrating a particular task between different groups of users and supervisors. For example, the user workstations 12, 112 and 114 may be connected to the supervisor workstation 14 through the server 122 for monitoring Exam A, while the user workstations 110 and 116 may be connected to the supervisor workstation 130 through the server 16 for monitoring Exam B. The specific communication network 18, 20 connections between the various components of the system 100 can also be mixed and matched as necessary—for example user workstations 12 and 110 may be connected to the server 122 via the internet, while user workstation 114 may be connected to server 122 or server 16 via a LAN. Similarly, communication network 18 connections between supervisor workstations and servers may be different from workstation to workstation.

One of the primary functions of the server set 106 is to facilitate and monitor connections and communications between the user and supervisor workstations. For example, if a particular connection is terminated accidentally or by a supervisor, the server set 106 can suspend the disconnected user's task and reconnect the user workstation to another available supervisor workstation. While the server set 106 can include a single server 106, it is preferable to include multiple servers. In this arrangement one or more of the servers can take on a load-balancing function that ensures appropriate distribution of system 100 processing over available components of the system 100. This function can include, for example, the capability of determining which supervisor workstations are most appropriate to receive newly connected user workstations. Other server functionality may include but is not limited to: switching to a different server's storage system when the current server's storage system reaches capacity, and switching session streaming data to another server when the current server's bandwidth limit is reached.

The key features and operation of the inventive system 10 or system 100 are controlled and configured by the main program executed by the system 10 or system 100. Essentially, the system 100 is substantially identical in principle to system 10 except that there may be multiple quantities of each system component. For example, system 100 with one user workstation, one supervisor and one server is identical to system 10. Different steps or program modules of the main program may be executed by different components of the system 10 or system 100 as a matter of design choice. If multiple servers are utilized in the system 100, one of the servers may perform load balancing functions in matching user workstations, supervisor workstations and optionally other servers to ensure efficient operation of the system 100.

Referring now to FIG. 6, a logic flow diagram representing the main program executed by one or more components of the inventive system 10 or system 100 is shown. For the sake of simplicity, the description of the main program below will refer to it being executed by various components of the system 100 (since systems 10, 100 are essentially identical other than the quantities of respective components). Furthermore, only a specific instance of the main program is described showing the operation of the system 100 during a typical session between a user and a supervisor. As previously described, the inventive system 100 concurrently executes multiple instances of the main program for each user that connects to the system 100. Furthermore, only those steps necessary or desirable for system 100 operation are shown. It is contemplated that execution of application programs and functions across several different computer systems may involve numerous conventional processes and steps not shown here because they are not part of the present invention.

In summary, monitored tasks (exams, etc.) are administered by the systems 10, 100 in an environment where the identity of the test taker can be confirmed and where the absence of reference materials and outside assistance can be monitored. The proliferation of efficient and wide-spread communication systems such as the Internet has made it convenient to administer tasks at a person's home or in other unsecured environment, which currently does not allow verification of user identity or authenticity of the effort. However the systems 10, 100 of the present invention enable monitoring and authentication of tasks performed by an identified person in a secured environment anywhere in the world.

Because of numerous abbreviations used in FIGS. 6 to 9, Table 1 below provides a useful definition guide to the terms used in the respective figures.

TABLE 1
(Terms in FIGS. 6 to 9)

| Abbreviation | Definition |
|---|---|
| User_N | a specific user utilizing the system 100 |
| | (N = 1, 2, . . . etc.) |
| UWS_N | user workstation 12 of User_N |
| EPSW | electronic proctoring “eProctoring” software |
| SV | supervisor |
| SVWS | supervisor workstation 14 |
| UMS_N | User_N monitoring system 46 |
| U_N_Authent | authentication information verifying the identity |
| | of User_N (biometric, image of ID, etc) |
| U_N_ID | unique User_N ID assigned to each user. |
| U_N_Session_LOG | session log of User_N current session utilizing |
| | the system 100, stored at the server 16 |
| U_N_Task | the particular task to be performed by User_N |
| | that must be monitored by the supervisor |
| | (exam, etc.) |
| U_N_AV | audio-visual (AV) data of the User_N activity |
| | (i.e. execution of the U_N_Task by the User_N) |
| | that is acquired by UMS_N |
| U_N_TD | User_N task data-the results of User_N's |
| | execution of U_N_Task (i.e. User_N's response |
| | to exam questions, etc.) |

The main program begins at a step 200 where a particular user (“User_N”) logs onto the system 100 via the user workstation 12 (“UWS_N”) to initiate a session in order to perform a particular task administered by the system 100 (such as an exam). The logon may be implemented via the User_N logging on to a remote website or other remote program interface serving as a front end for the system. Preferably the user enters a unique user ID (“U_N_ID”) during this step. This U_N_ID may be assigned by the provider of the task or it may be assigned in a different manner (for example when the user first installs software necessary to utilize the system 100—see step 206 below) At a step 202, the system 100 determines if the UWS_N already has necessary software (“ePSW” or “eProctoring” application program) to execute the required portions of the main program during further operation of the system 100. If the ePSW is present on the UWS_N, (for example if the User_N has previously used the system 100) the main program proceeds to a step 204. Otherwise, at a step 206 the system 100 downloads the ePSW to UWS_N and executes it. Optionally, ePSW is always automatically downloaded to the UWS_N at this step and executed, in case installation of the ePSW is undesirable.

At the step 204, the system 100 determines if a supervisor (“SV”) is available to monitor the User_N's performance of the task. For example, this may be done by the server set 106 monitoring the connected supervisor workstations of the supervisor workstation set 104 for a predetermined period of time to determine if a particular supervisor is available to take on an additional user. If the SV is available, the program proceeds to a step 208. Otherwise, the program proceeds to a step 210, where the User_N is informed that no SV is currently available and to attempt a login later. Optionally, the program proceeds to a step 212 where the system 100 continues to poll supervisor workstations to find an available slot for the User_N and then notifies the User_N by email, instant message or other means when an SV becomes available.

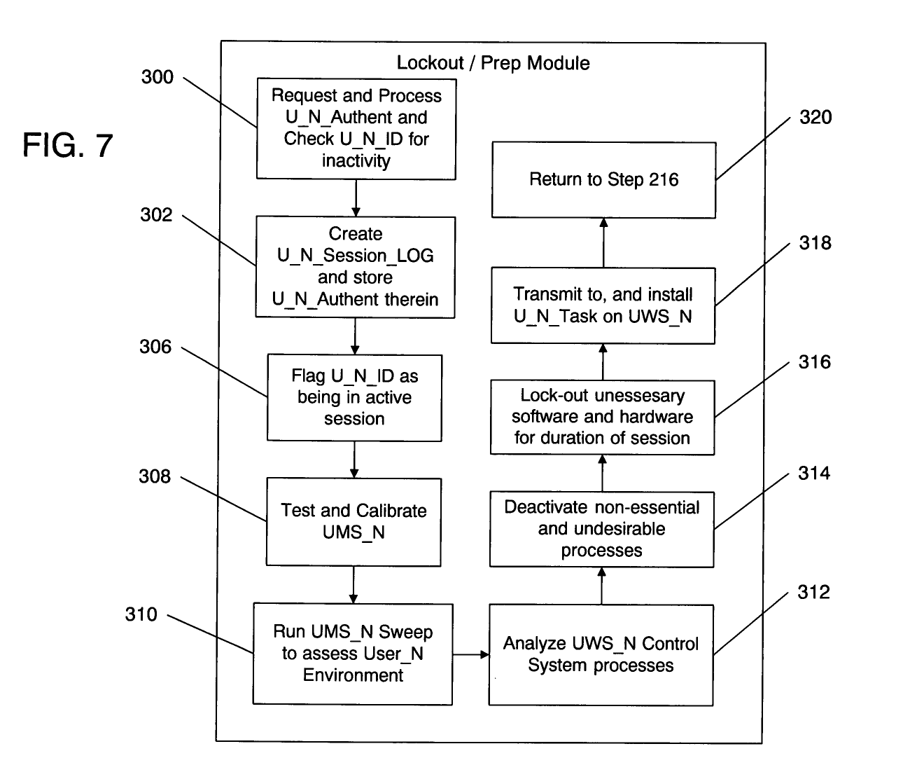

At the step 208, the system 100 connects the UWS_N to an available supervisor workstation (“SVWS”), for example, the supervisor workstation 14, via communication networks 18, 20 and optionally verifies the integrity of the connection. The program then proceeds to a step 214, where a lockout and preparation program module (shown in FIG. 7) is executed. The purpose of this module is to authenticate and verify the User_N and to prepare the UWS_N by calibrating the necessary workstation components and by locking out any software and hardware systems at the UWS_N that may interfere with the task that the User_N will be performing later in the session or that may enable the User_N to utilize unauthorized means to complete the task (i.e. to “cheat”).

Referring now to FIG. 7, a lockout and preparation program module invoked by the program of FIG. 6 and executed by the system 100 is shown. At a step 300, the system 100 optionally requests verification of User_N's identity in form of authentication information (“U_N_Authent”) that may be acquired through the security system 36 (for example through a biometric identification system such as a fingerprint, retinal, or a facial scan) or via other means—for example requiring the User_N to display a valid ID such as a Driver's license to the camera 48 and then capturing that image. At this step the system 100 verifies that U_N_ID is not currently being used in another active session. This prevents the User_N from using his U_N_ID in multiple sessions or from lending his or her U_N_ID to someone else. At a step 302, the system 100 creates a session log record (“U_N_Session_LOG”) in which all relevant session information regarding User_N's performance of the task will be stored, and stores U_N_Authent in the newly created U_N_Session_LOG.

At a step 306, the system 100 flags U_N_ID as being in active session to ensure that this ID cannot be used by anyone else until the current session is complete. At a step 308, the system 100 calibrates and tests the user monitoring system 46 (“UMS_N”) that will be utilized by SV to monitor and record User_N's activities in a predefined work space around the UWS_N during User N's performance of the task. At a step 310, the system 100 runs a sweep of the UMS_N to show the environment or work space of User_N to the SV to ensure that the area is clear or any other people or unauthorized materials. This may be accomplished by causing a motorized camera 48 to move in its maximum field of view in a predefined pattern. Preferably, the maximum field of view of the camera is as close as possible to 360 degrees in the horizontal plane and at least 180 degrees in the vertical plane. If such a wide field of view is not possible the camera 48 may still be utilized as long as the field of view is sufficient to provide an acceptable image of the user's environment or work space.

At a step 312, the system 100 analyzes the applications programs and other processes active on the UWS_N (i.e. being executed by user control system 22) to determine which application programs and processes are the non-essential or undesirable and displays results on the SVWS display system to the SV. Any application programs or processes that are not required by the system 100 to run the main program can be considered and flagged as non-essential or undesirable. This may include, but is not limited to, a web-browser, email program, program to access other files on UWS_N, processes that allow connection of an additional display system to the UWS_N, and programs that enable communication with other computers outside of the system 100. Preferably, these programs/applications are flagged automatically by the system 100 by comparing them to a database of known programs/processes, but the SV is able to dynamically review current application programs/processes on the UWS_N and selectively flag particular programs or processes as undesirable.

At a step 314, the system 100 deactivates the flagged programs/processes and proceeds to a step 316 where these and other undesirable/unnecessary programs, processes or hardware systems, are locked out for the duration of the session (i.e. they may no longer be activated or used at the UWS_N until the session ends. Steps 312 to 316 essentially ensure that the UWS_N is capable of running only programs necessary for the system 100 and unable to run any programs which may disturb the integrity of the task to be performed by the User_N.

At a step 318, the system 318 transmits the data representative of the task to be performed by the User_N (“U_N_Task”), for example an exam, to the UWS_N and installs it thereon for utilization by the User_N. At a step 320, the system returns to a step 216 (FIG. 2) where the User_N is instructed to begin, and begins to perform the task by utilizing the U_N_Task. The U_N_Task may be a conventional static question and answer exam, or it may be an adaptive exam, that dynamically builds a testing application specifically tailored to the User_N. Computer adaptive testing methodologies are developed to select questions with a specific level of difficulty based on previous responses. Thus, a U_N_Task that incorporates an adaptive testing engine “adapts” the question selection process according to User_N's abilities, eliminating questions that are too easy or too difficult for them. This method of testing allows for the accurate test of ability of the person with far fewer questions.

Adaptive questioning is the most efficient, effective means of knowledge-based testing. Responses provide the adaptive testing engine with the information it needs to deliver only those questions that are appropriate for individual abilities. The benefits of this approach include: (1) Appropriate questioning, (2) Reliable measure of technical proficiency, and (3) Results show areas of strength and weakness clearly and accurately

The adaptive test development process is much more complex than that required by a non-adaptive test. Few companies that specialize in testing and test actually deploy adaptive testing methodology. The use of adaptive testing should be an important consideration and requirement when evaluating an exam product or service.

The adaptive U_N_Task (i.e. the “adaptive testing engine”) may operate as follows. Once the adaptive U_N_Task has evaluated a response and determined the appropriate level of difficulty for the next question, a follow-up is randomly selected from a pool of available questions at the determined difficulty level. For this purpose, the adaptive U_N_Task maintains several pools of questions at various difficulty levels. The random selection process allows individuals to take a test more than once and receive different questions that are assigned the same level of difficulty each time they take the test. This process helps ensure the test result is a true measure of the individual's knowledge, and not a reflection of their ability to learn and study test questions.

The advanced methodology of the adaptive U_N_Task breaks each test into a number of sub-skills (for example, ten sub-skills). Each sub-skill contains a pool of questions at all difficulty levels. The adaptive U_N_Task selects the next question for that sub-topic based on prior responses within that sub-topic. Thus the test adapts independently within each of the sub-topics.

By adapting independently within sub-topics, the knowledge in one sub-topic does not impact the difficulty level of questions in other sub-topics. This allows each sub-topic to be independently evaluated and identified as a specific strength, weakness or proficiency. Tests that do not adapt independently within sub-topics cannot provide accurate strengths and weaknesses because knowledge levels in other sub-topics have influenced the difficulty of questions in each sub-topic.

Question weights are values assigned to each question measuring the difficulty level and relative importance of the material being tested. Typically, the higher the weight, the greater the degree of difficulty or importance. In an adaptive test, the number of correctly answered questions is not as important as the difficulty and relevance of those questions. For this reason, all adaptive U_N_Task questions should weighted for difficulty and importance. The more difficult the question, the more credit received for a correct answer and the less credit lost for incorrect answers.

Weighted questions allow for much more granular insight into proficiency levels, thus enabling the individual(s) using that result to make better, more educated decisions related to hiring, training, professional development and resource management. Further, in an adaptive test administered via the adaptive U_N_Task, test takers will receive questions of varying difficulty levels based upon prior responses. If there were no weights, the scoring would not be fair to those who were doing well and receiving more difficult questions. Assigning each question with weights representing different areas of knowledge enables independent scoring in those areas.

The adaptive U_N_Task questions are uniquely formulated to provide the maximum feedback, enabling the test taker to express a very wide range of understanding in each question. This may be accomplished through a methodology called “Multiple Correct Response.” For example, each question may have five possible answers, of which up to two can be correct. The test taker is never told how many correct answers there are to any given question, but are allowed to select up to two answers. Credit is gained for every correct answer selected and lost for every wrong answer selected. Credit is also lost for every correct answer not selected.

Multiple correct answers allow for very detailed feedback since they provide increased accuracy, reliability, and usability. By enabling the selection of up to two answers, there are actually 20 unique answer combinations to every question. Each one of these 20 combinations implies a different level of knowledge about the subject, each has its own unique credit value based upon the combination of answers selected and not selected, and each of the 20 answer combinations leads to a different level of follow-up question within the adaptive U_N_Task.

Where a traditional test with one correct answer typically provides binary feedback (correct or incorrect), an exemplary adaptive U_N_Task's 20 answer combinations allow the test taker to express a wide range of understanding and receive the appropriate amount of credit-with each question. When combined over the entire test, this detailed feedback on each question assures a more reliable and accurate test of proficiency.

Percentiles may be used as a form of ranking. Thus, a score in the 60th percentile means that score is higher than 60 percent of all scores ever given in that exam. The value of a percentile is determined by the make-up of the population contributing to the test scores. A percentile is a relative measure determined by its population. For example, the adaptive U_N_Task's percentile pools are populated entirely with scores from highly skilled professionals who make their living in the tested technology. A percentile of 60 indicates greater proficiency than 60 percent of the professionals who have taken the test.

Each adaptive U_N_Task system test may break the test subject down into a number pf sub-skills, for example, 10, that are unique and specific to that test subject. Such tests adapt independently within each of these sub-topics. This means that performance in one sub-skill does not impact the difficulty level of questions in other sub-topics, allowing proficiency in each sub-topic to be independently evaluated.

The adaptive U_N_Task's review of absolute strengths and weaknesses is an important tool in both individual and group skill analysis. The adaptive U_N_Task's analysis further helps identify individuals with the specific skills needed on a project. It can also be used in establishing individual training needs. At the department or enterprise level, it identifies skill gaps to help pinpoint skills for new hires and evaluate the skill mix on project teams.

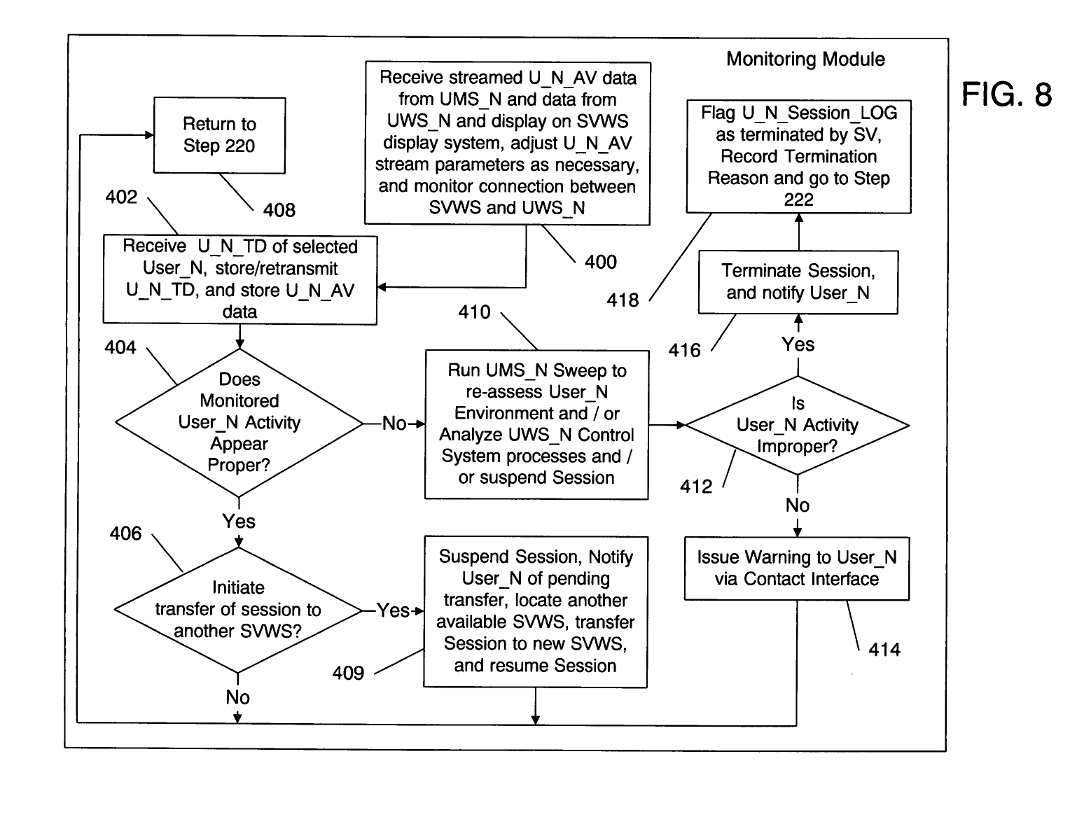

At a step 218, the system 100 executes a monitoring program module (shown in FIG. 8). The purpose of this module is to enable to SV to monitor User_N's activities at the UWS_N, to communicate with the user if necessary (via chat or other means) to warn of activity that appears improper, to enable the SV or the system 10 to transfer the session to another SVWS, to control the UMS_N to change the SV's view of User_N's environment or work space, and to terminate the task and the session if the User_N engages in improper behavior.

Referring now to FIG. 8, a monitoring program module invoked by the program of FIG. 6 and executed by the system 100 is shown. While this module is shown as a logic flow diagram it should be understood that several of its steps (for example steps 400 to 404) are actually being performed concurrently and continually after their first execution.

At a step 400, the SVWS receives streamed AV data representative of the User_N's environment at the UWS_N (“U_N_AV”) from the UMS_N and displays it to the SV on the SVWS display system. The SVWS may also receive and display data from UWS_N control system 22 representative of any application programs or processes that the User_N may run during the session at the UWS_N. The SV can adjust the U_N_AV parameters, such as allowed bandwidth, color and volume on the SVWS as necessary. At this step, the system 100 also initiates continual monitoring of the connection between the UWS_N and the SVWS.

At a step 402, the system 100 receives task data (“U_N_TD”) from the user, representative of User_N's execution of the U_N_Task (i.e. User_N's response to exam questions, etc.) and stores U_N_TD at a server along with the U_N_Session_LOG and/or re-transmits the U_N_TD to a third party that administers the task (i.e. to an examination authority). Optionally, the U_N_TD may be displayed to the SV on the SVWS display system or, U_N_TD may be concealed from the SV as a matter of design choice (for example if the SV's only duty is to monitor User_N's physical activities during User_N's performance of the task).

At a step 404, by observing the U_N_AV and/or other data from the UWS_N, the SV determines whether or not User_N's activities at the UWS_N appear proper. As previously described, this observation of User_N's activities is a continual process as the SV observes the User_N—the SV is not actually polled by the system 100 to determine whether there is any improper User_N activity. Optionally, certain User_N activities can be detected as improper automatically by the system 100—for example, the User_N or someone near User_N speaking, the User_N leaving the range of the UMS_N, or the User_N trying to activate a prohibited program or process on UWS_N, in which case the system 100 informs the SV of detected improper activity. For example, if the SV is monitoring multiple users, only one audio stream may be active at the SVWS—in this case, if inappropriate sound is detected User_N's environment, the system 100 automatically makes the audio component of U_N_AV active so that the SV can hear the inappropriate sound.

If the monitored User_N activity appears proper, at step 406, the system 100 determines if the session needs to be transferred to another SVWS. This is not a continuous polling function by the system 100—rather the step 406 represents the system 100 waiting for an indicator of whether or not the current session needs to be transferred either at the request of the SV (if the SV needs to leave the SVWS for some reason) or because the monitored connection between SVWS is lost or is in danger of being lost (as determined by the system 100). If the session does not need to be transferred, at a step 408, the system 100 returns to a step 220 where if the U_N_Task is complete, it proceeds to a step 222, and otherwise returns to the step 218 (i.e. continues execution of the monitoring module of FIG. 8). If the session does need to be transferred, then at a step 409, the system 100 suspends the session, notifies the User_N of a pending transfer to another SV, locates an available SVWS (for example utilizing load balancing, “round-robin” assignment, or via another server functionality), and transfers the session to a new SVWS for monitoring by a new SV. The program then proceeds to the step 408.

Returning now to FIG. 8, if at the step 404 the monitored User_N activity appears improper, program proceeds to a step 410 where the SV can do one or more of the flowing: (1) Run an UMS_N sweep to re-assess the User_N environment or to zero-in on a particular area of the User_N's environment; (2) examine the current processes being executed (or that attempted to execute) by the UWS_N control system; and (3) suspend the session (i.e. suspend the User_N's ability to utilize the U_N_Task) while the SV assesses the situation. The system 100 then proceeds to a step 412. Optionally, if at the step 404, the User_N's activities appear blatantly improper, this step may be skipped, and the SV can proceed directly to a step 416.

At the step 412, the SV decides whether the User_N activity detected at the step 404 was actually improper. If the detected activity was not actually improper, the program proceeds to an optional step 414 where the SV can warn the User_N that appearance of an improper activity was detected via a contact interface between the SVWS and UWS_N, such as a chat or other messaging interface. The program then proceeds to the step 408. If the User_N, activity was actually improper, the program proceeds to the step 416.

At the step 416, the SV instructs the system 100 to terminate the session by terminating User_N's access to the U_N_Task and to notify the User_N that the session was terminated for detection of improper activity by the User_N.

At a step 418, the system 100 flags the U_N_Session_LOG as terminated by SV, optionally records the termination reason given by the SV, and proceeds to the step 222.

Returning now to FIG. 6, at the step 222, the system 100 finalizes and stores the U_N_Session_LOG at a particular server (the server that handled the connection between the UWS_N and SVWS or, for example, a specific server that is designated for storing all session logs).

At an optional step 224, the system 100 then removes the installed U_N_Task from the UWS)_N. This step may be essential for tasks that are exams, in that most exams are considered proprietary and are thus inappropriate to leave in the user's possession after the exam is completed. At a step 226, the system 100 disconnects the UWS_N from the SVWS, and flags the SVWS as having an available slot for receiving a connection from a different user, and ends the session at a step 228.

Because a typical supervisor (for example at a supervisor workstation 14) may be required to monitor activities of multiple users, it would be desirable to provide the display system 72 of the supervisor workstation with an advantageous front end interface that readily supports participation by the supervisor in multiple sessions conducted by the system 100. The preferred embodiment of such a front-end interface depends on whether the display system 72 includes a single monitor or multiple monitors.

Referring now to FIG. 9, a graphical representation of an exemplary supervisor front end interface displayed on a single monitor display system 72 is shown as an interface 500. It should be noted that the interface 500 only shows the specific front-end elements necessary for the system 100. Furthermore, the exact positioning of the various interface 500 elements is shown by way of example only—and the elements may be readily re-arranged and re-positioned as a matter of design choice without departing from the spirit of the invention.

The interface 500 includes a user monitor window 502 consisting of an image area 504 for displaying the video portion of the U_N_AV stream, a set of AV stream controls 506 for controlling the allowed bandwidth of the stream, activating or deactivating the audio portion of the U_N_AV stream and whether or not the stream is color or grayscale, and an AV stream information panel 508 which can include one or more of the following information items: (1) whether or not the current user monitor window is active; (2) bandwidth information for the U_N_AV stream, (3) the User_N's name or other form of ID. The interface includes several other user monitor windows (for example windows 510, 512, and 514), substantially similar to the user monitor window 502. The specific amount of displayed user monitor windows shown in the interface 500 is selected as a matter of design choice depends largely on one or more of the following factors: (1) the maximum number of users that may be assigned to the supervisor by the system 100; (2) the size of the display system 72; and (3) the resolution of the display system 72. Preferably, to focus on in-depth monitoring of a specific user, the supervisor selects the desired user monitor window corresponding to that specific user using the data input system 64, such as a mouse—that selected user monitor window becomes the “active” window and affects other portions of the interface 500.

The interface 500 also includes a U_N_Task window 516 for displaying data received from the active User_N, that may include data on running applications and/or processes received from the UWS_N during execution of the lockout/preparation and monitoring modules, or optionally may display captures representative of User_N's performance of the U_N_Task. A chat (or equivalent text communication) window 518 is provided for the supervisor to send and receive text messages to and from monitored users, for example enabling the supervisor to warn a user about inappropriate activity, and enabling the user to ask the supervisor to suspend the session (if rules of the task allow it) for the user to use a restroom facility.

An optional set of hotkey message buttons 520 with predetermined messages may be provided for the supervisor that may include chat messages commonly used by the supervisor (such as “stop talking” or “please don't move the camera”). An optional set of control hotkeys 522 may also be provided to enable the supervisor to assign common functions such as transferring one or more user sessions to another supervisor, terminating the active session, or performing a UMS_N sweep of the active User_N's test environment to multiple hotkeys. The control hotkeys 522 may also include controls to enable the supervisor to control precise motion of the UMS_N to view a specific area of the user's environment or work area. Finally, an optional miscellaneous information window 524 may also be included in the interface 500, for enabling the supervisor to receive information from the server(s) regarding functions and/or operations of the system 100.

Referring now to FIG. 10 a graphical representation of an exemplary supervisor front end interface displayed on a multiple monitor display system 72 is shown as an interface 600. It should be noted that the interface 600 only shows the specific front-end elements necessary for the system 100. Furthermore, the exact positioning of the various interface 600 elements is shown by way of example only—and the elements may be readily re-arranged and re-positioned as a matter of design choice without departing from the spirit of the invention.

The multiple display interface 600 consists of a user monitor display 602 for displaying multiple user monitor windows 604 (each substantially corresponding to the user monitor window 502 of FIG. 9), and a separate, active display 606 for displaying information relative to the currently active user monitor window from the user monitor display 602, and for displaying functional elements usable by the supervisor. Essentially, the various elements of the active display 606 correspond to similar elements shown in FIG. 9—the U_N_Task window 608, the chat window 610, the hotkey message buttons 612, the control hotkeys 614, and the miscellaneous information window 616, correspond to the U_N_Task window 516, the chat window 518, the hotkey message buttons 520, the control hotkeys 522, and the miscellaneous information window 524, respectively. If more than two displays are included in the display system 72, the additional displays can be utilized as additional user monitor displays to display additional user monitor windows, while only a single active display 606 is necessary.

In an alternate embodiment of the invention, the active display 606 may have an identical interface to interface 500, enabling display of additional user monitor windows on the active display 606.

The system 10 and 100 are preferably modular in nature where various modules of the main program shown in FIG. 6 may be re-configured, removed, or new program modules added as a matter of design choice to provide other useful and advantageous functionality that utilizes the novel multimedia communication features of the present invention. Such functional variation may include but is not limited to utilization of a modified system 10 or 100 for remote instruction, for providing remote technical support, for utilization as a dating service, and for remote recruitment and interviewing (for example, in conjunction with an interactive AV U_N_Task module).

One functional variant utilization of system 100 is shown in FIG. 11 as an exemplary embodiment of a remote instruction (hereinafter “RI”) main program that can be executed by the system 100 to enable an instructor, using for example a supervisor workstation 14 or equivalent from the supervisor workstation set 104, to provide remote instructions to a number of students utilizing, for example, user workstations 12, 110, 112, 114, or equivalent from the user workstation set 102. One more servers from the server set 106 may be utilized to aid in the execution of the RI main program, but a server is not absolutely necessary for the program's execution, as the supervisor (or instructor) workstation used by the instructor can readily assume the required server functionality. The main differences between the main program of FIG. 6 and the RI main program of FIG. 11 are that AV data representative of the instructor is transmitted to the users connected to the instructor's workstation, and that two-way transmission of AV and application data (such as instruction materials) between the instructor and users is provided so that an interactive class session may be conducted. Thus, the system 100 configured for delivery of remote instruction by utilizing the RI main program is not concerned with monitoring the users—rather its functionality is directed to efficient and advantageous two way multimedia communication between the instructor and the users. The only necessary hardware modification of the system 100 for the delivery of remote instruction is that each supervisor (i.e. instructor) workstation should include the multimedia input system 66 such that AV data from the instructor may be transmitted to each user during a class session.

Referring now to FIG. 11, a logic flow diagram representing the RI main program executed by one or more components of the inventive system 100 is shown. For the sake of simplicity, the description of the RI main program below will refer to it being executed by various components of the system 100 (since systems 10, 100 are essentially identical other than the quantities of respective components). Furthermore, only a specific instance of the RI main program is described showing the operation of the system 100 during a typical session between an instructor and one or more users. The inventive system 100 is capable of concurrent execution of multiple instances of the RI main program for each instructor that connects to the system 100 to provide instruction to one or more users. Furthermore, only those steps necessary or desirable for system 100 operation in executing the RI main program are shown. It is contemplated that execution of application programs and functions across several different computer system may involve numerous conventional processes and steps not shown here because they are not part of the present invention.

Because of numerous abbreviations used in FIG. 11, Table 2 below provides a useful definition guide to the terms used in the respective figures.

TABLE 2
(Terms in FIG. 11)

| Abbreviation | Definition |
|---|---|
| User_N | a specific user utilizing the system 100 |
| | (N = 1, 2, . . . etc.) |
| UWS_N | user workstation 12 of User_N |
| RISW | remote instruction software |
| INST_WS | instructor's workstation (equivalent to supervisor |
| | workstation 14) |
| UMS_N | User_N monitoring system 46 |
| U_N_AV | audio-visual (AV) data of the User_N activity that is |
| | acquired by UMS_N |
| INST_AV | audio-visual (AV) data of the instructor activity that is |
| | acquired by the multimedia input system 66 from |
| | INTS_WS |

The RI main program begins at a step 650 where a particular user (“User_N”) logs onto the system 100 via the user workstation 12 (“UWS_N”) at a predefined time to join a previously scheduled class session. The logon may be implemented via the User_N logging on to a remote website or other remote program interface serving as a front end for the system, for example by the User_N entering an unique ID and password. At an optional step 652 the system 100 requests verification of User_N's identity in form of authentication information that may be acquired through the security system 36 (for example through a biometric identification system such as a fingerprint, retinal, or a facial scan) or via other means—for example requiring the User_N to display a valid ID such as a Driver's license to the camera 48 and then capturing that image. This optional step may be utilized if secure (i.e. more than just the User_N's ID and password) verification of User_N's attendance at the class session is desired.

At a step 654, the system 100 determines if the UWS_N already has necessary software (“RISW” or remote instruction application program) to execute the required portions of the RI main program during further operation of the system 100. If the RISW is present on the UWS_N, (for example if the User_N has previously used the system 100 for receiving remote instruction) the RI main program proceeds to a step 656. Otherwise, at a step 658 the system 100 downloads the RISW to UWS_N and installs it (for example in data storage 28).

At the step 656, the system 100 connects the UWS_N to a predetermined instructor workstation (“INST_WS”), for example, the supervisor workstation 14, via communication networks 18, 20 and optionally verifies the integrity of the connection. The program then proceeds to an optional step 660, where the system 100 calibrates and tests the user monitoring system 46 (“UMS_N”) that will be utilized by the system 100 to provide AV data representative of User_N (i.e. U_N_AV data) to the instructor. Preferably, the multimedia input system 66 is pre-calibrated and tested at the INST_WS prior to accepting connection from the UWS_Ns.

At a step 662, the system 100 streams U_N_AV data to the INST_WS from each connected User_N's UMS_N and displays the data on the INST_WS display system (for example display system 40). At this step the instructor is able to adjust the parameters of each U_N_AV stream as necessary (for example lowering or increasing the bandwidth or changing one or more U_N_AV streams to grayscale instead of color if the displayed image is of poor quality. Concurrently, at a step 664, the system 100 streams AV data representative of the instructor's activities in the area of INST_WS (“INST_AV”) from INST_WS and displays the INST_AV stream (and provides audio) at each connected UWS_N.

At a step 666, the system 100 once the two-way AV streams between the INST_WS and all connected UWS_Ns are established, and the scheduled time for beginning the class session is reached, the system 100 begins the class session. After step 666, the class session may be locked (i.e. no further User_Ns can join the class session in progress. Optionally, additional User_Ns can join the class session during a specified time window after the session has started (or during the entire length of the session).

At a step 668, the class session is conducted between the instructor and User_Ns in an interactive manner, for example utilizing two-way AV communication, remote application sharing (i.e. two way transmission of application data between INST_WS and the connected USW_Ns), chatting, or by other suitable means. Optionally, the entire class session including one or more of the following: U_N_AV and INST_AV data, application share data, and chat transcripts may be recorded and stored at the INST_WS on a server (for example on the server 16). This may be advantageous for evaluation of the instructor's performance, or for use by other User_Ns who were not able to participate in the class session.

When the class session is complete, at an optional step 670, the system 100 may credit each User_N who participated in the class session with attendance at the session. This may be done by recording a User_N's attendance in a database stored at the INST_WS or at a server, and/or by providing each User_N with a computer record of attendance (such as a printable certificate that may optionally includes information authenticating the User_N, such as a picture of the User's ID acquired at the step 652). At a step 672, the system 100 ends operation of the RI main program and disconnects the UWS_Ns from the INST_WS.

Because an instructor typically conducts a class session with multiple users, it would be desirable to provide the display system 72 of the instructor/supervisor workstation with an advantageous front end interface that readily supports administration of class sessions by the instructor with multiple users. It would also be desirable to provide a corresponding front end interface for the display system 40 on each UWS_N to facilitate each User_N's participation in remote instruction class sessions.

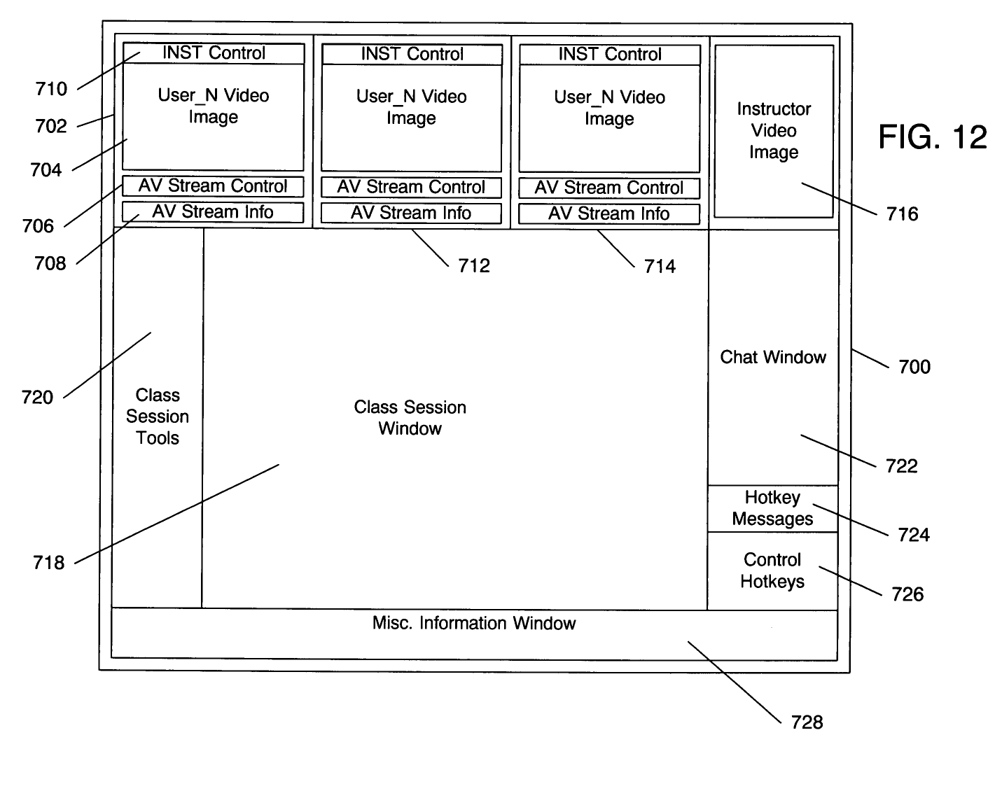

Referring now to FIG. 12, a graphical representation of an exemplary instructor front end interface displayed on a single monitor display system 72 is shown as an interface 700. It should be noted that the interface 700 only shows the specific front-end elements necessary for the system 100 implementing the RI main program of FIG. 11. Furthermore, the exact positioning of the various interface 700 elements is shown by way of example only—and the elements may be readily re-arranged and re-positioned as a matter of design choice without departing from the spirit of the invention.

The interface 700 includes a user image window 702 consisting of an image area 704 for displaying the video portion of the U_N_AV stream, a set of AV stream controls 706 for controlling the allowed bandwidth of the stream, activating or deactivating the audio portion of the U_N_AV stream and whether or not the stream is color or grayscale, and an AV stream information panel 708 which can include one or more of the following information items: (1) whether or not the current user image window is active; (2) bandwidth information for the U_N_AV stream, (3) the User_N's name or other form of ID. The user image window 702 also includes an instructor control 710 which enables the instructor to allow or disallow the audio portion of the U_N_AV stream from User_N corresponding to the user image window 702. The interface 700 preferably includes several other user image windows (for example windows 712 and 714), substantially similar to the user image window 702. The specific amount of displayed user image windows shown in the interface 700 is selected as a matter of design choice depends largely on one or more of the following factors: (1) the maximum number of users that may be assigned to the instructor by the system 100; (2) the size of the display system 72; and (3) the resolution of the display system 72. An optional instructor image window 716 enables the instructor to view the video potion of the INST_AV stream leaving his or her workstation.

The interface 700 also includes a class session window 718 for displaying application share data that is transmitted to all connected UWS_Ns under the control of the instructor, while a class session tool menu 720 allows the instructor to modify data displayed in the class session window 718. In its simplest form the class session window 718 can be used to enable a “whiteboard-like” function where changes made by the instructor using the tool menu 720 to data in the class session window 718 are transmitted to all connected User_Ns.

A chat (or equivalent text communication) window 722 is provided for the instructor to send and receive text messages to and from connected User_Ns. An optional set of hotkey message buttons 724 with predetermined messages may be provided for the instructor that may include chat messages commonly used by the instructor (such as “pay attention”). An optional set of control hotkeys 726 may also be provided to enable the instructor to assign common functions such as activating additional applications or terminating the class session to multiple hotkeys. Finally, an optional miscellaneous information window 728 may also be included in the interface 700, for enabling the instructor to receive information from the server(s) regarding functions and/or operations of the system 100. It should also be noted that similarly to a multiple monitor display system 72 described above, in connection with FIG. 10, use of additional monitors in the display system 72, enables addition of multiple front end interfaces on each additional monitor dedicated to displaying additional user image windows (similar to the front end interface 602 of FIG. 10).

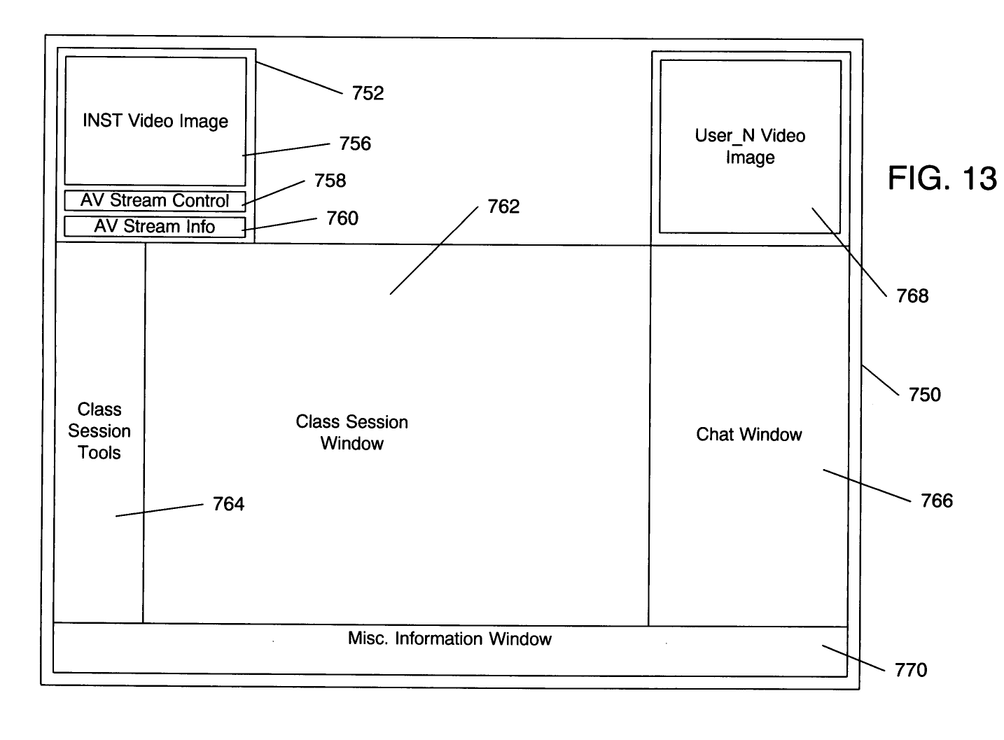

Referring now to FIG. 13, a graphical representation of an exemplary user front end interface displayed on the display system 40 is shown as an interface 750. It should be noted that the interface 750 only shows the specific front-end elements necessary for the system 100 implementing the RI main program of FIG. 11. Furthermore, the exact positioning of the various interface 750 elements is shown by way of example only—the elements may be readily re-arranged and re-positioned as a matter of design choice without departing from the spirit of the invention.

The interface 750 includes an instructor image window 752 consisting of an image area 756 for displaying the video portion of the INST_AV stream, a set of AV stream controls 758 for controlling the allowed bandwidth of the stream, activating or deactivating the audio portion of the U_N_AV stream and whether or not the stream is color or grayscale, and an AV stream information panel 760 which can include bandwidth information for the INST_AV stream. An optional user image window 768 enables the user to view the video potion of the U_N_AV stream leaving the UWS_N.

The interface 750 also includes a class session window 762 for displaying application share data that is transmitted from the INST_WS during the class session, while an optional class session tool menu 764 may allow the User_N to modify data displayed in the class session window 762 such that the instructor and other User_Ns can view the User_N's efforts.

A chat (or equivalent text communication) window 766 is provided for the User_Ns to send and receive text messages to and from the instructor. Finally, an optional miscellaneous information window 770 may also be included in the interface 750, for enabling the student to receive information from the server(s) regarding functions and/or operations of the system 100.

In an alternate embodiment of the system 100 executing the RI main program, the RI main program can be configured for remote technical support and/or system administration by replacing the application share feature of the RI main program by a module capable of executing steps 312 and 314 of FIG. 7 so that system applications and/or processes on connected UWS_Ns may be analyzed by the instructor (in this case a technical support representative) such that UWS_Ns may be remotely modified by the support representative using the INST_WS for technical support or system administration purposes. The User_N (e.g. a customer) is made to feel comfortable that the support representative is actually looking into the problem figuratively. Furthermore, the bi-directional audio-visual communication between the User_N and the support representative serves to improve the quality of the delivered service.

In yet another embodiment of the present invention, the system 10 or 100 may be used to administer remote personal interviews, where an interviewee working on a remote UWS_N can interactively communicate with the interviewer using a SWVS across geographically distributed locations. This allows interviews of distant candidates without the need to travel between locations. In accordance with this embodiment, the interviewer may utilize one or more of the elements of the above-described main program of FIG. 6 to test one or more interviewee skill sets during the interview using a specially configured U_N_Task module with multimedia capabilities. Furthermore, the interview record may be recorded and stored for later viewing by the interviewer and other interested parties. In this manner, the human resources hiring decisions can be facilitated at a minimal cost to a company. By way of example, a multimedia U_N_Task module used in accordance with interviewing embodiment of the present invention enables AV testing that records the User_N's audio and visual responses to the questions posed during execution of the U_N_Task. Thus the interviewer can not only receive answers to desired questions, but is also presented with an opportunity to observe the User_N's countenance and hear how the questions are answered.

The various above described embodiments and components of the inventive system 10, 100 all utilize real-time streaming of audio-visual data from user workstations to one or more supervisor workstations (through one or more servers). Preferably, the inventive system 10, 100 incorporates a novel client side real time streaming of audio visual data, rather than a server-side streaming more commonly used by previously known systems. This approach has two main advantages: (1) It enables real time streaming AV data playback for the supervisor, not the “store and forward” approach more commonly used in the industry, and (2) the entire client side streaming process occurs over a very low bandwidth internet connection, unlike some of the video conferencing solutions which require a very high network bandwidth.

The inventive audio-visual data streaming approach may be described in reference to four elements: streaming setup, audio streaming, video streaming, and synchronization for playback, each described in greater detail below. While the elements are described with reference to Microsoft Windows™ operating system, it should be understood to one skilled in the art that these elements may be readily configured using similar program functions in other operating systems (such as Apple MacOS™, Linux, etc.) as a matter of design choice without departing from the spirit of the invention.

Before initializing any work, the a local program module at UWS_N checks for a network connection at the UWS_N. If found, the local module queries the main program for the settings that tells the local module the address and port numbers of the system 100 server. Before attempting to login to the server, the local module attempts to communicate with the server to see whether it is up and running or not. If server is running, the local module then identifies itself as a candidate taking a test, and asks the server to assign a supervisor. If one is available then the test, as well as audio and video capture and streaming, initiate (this process is described above in connection with FIGS. 6 and 7).

Audio is captured using Windows multimedia API and is preferably compressed real-time to an appropriate format using windows ACM (Audio Compression Manager), and is streamed with a time stamp to the server where it is saved and simultaneously forwarded to an SVWS. All this occurs in a separate thread of execution so other tasks can be running at the same time.

In the start-up phase of the local module, it initializes the web cam that is part of the UMS_N. An initial frame of the screen is captured and split into smaller sub-frames the number of which is determined by the resolution of the candidate screen. The sub frames are then compressed and streamed to the server where it gets saved and simultaneously being forwarded to the SVWS. A time-stamp is sent along with each frame information to be considered for synchronization with audio stream for playing-back the recorded file. The initial frame is saved in a local buffer at the UWS_N. Next subsequent frame is divided into sub-frames. Each sub-frame is compared against the previously saved sub-frames. If the new sub-frame is identical to the previous one, it is ignored. Otherwise, it gets compressed and streamed to the server and supervisor. Once all sub-frames in a frame are worked upon (streamed or ignored) the new frame replaces the one existing in the buffer for comparison with next frame. This procedure continues till the end of the session.

Recorded AV data play-back is a difficult task because it requires synchronization in terms of timing. Since this process may have to operate in a very low network bandwidth, some frames might be dropped while streaming video, so it is particularly difficult to play audio and video synchronously. In this case the time-stamp sent for each frame is particularly advantageous. Taking into account the relative certainty that the audio is a continuous stream which is synchronized in time using Windows multimedia play-back functions, the local module application establishes a loop to check what audio time frame is being played now, and check whether a video frame exists that should be played at this time or not, If any, it displays the frame, otherwise, continues with the previous frame.

It should be noted that other forms of AV streaming (for example conventional products available on the market) may also be readily utilized in conjunction with the inventive system 10, 100 as a matter of design choice without departing from the spirit of the invention.

Thus, while there have been shown and described and pointed out fundamental novel features of the invention as applied to preferred embodiments thereof, it will be understood that various omissions and substitutions and changes in the form and details of the devices and methods illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. It is the intention, therefore, to be limited only as indicated by the scope of the claims appended hereto.

We claim:

1. A data processing and communication system for at least one of: administrating, monitoring, verifying and authenticating remote activities of a user over a communication network, comprising:
at least one user workstation, utilized by the user, connected to the communication network,
a supervisor workstation, utilized by a supervisor, connected to said at least one user workstation through the communication network;
data acquisition means, located at each of said at least one user workstation, for capturing user data representative of activities of the user at each said at least one user workstation;
data transmission means for transmitting said user data to said supervisor workstation such that said supervisor can monitor said user data in real-time;
data recording means for recording said user data in a session record; and
data storage means for storing said session record for future authentication of performance of said remote user activities and the user's identity.

2. The data processing and communication system of claim 1, further comprising a server, connected to the communication network, said server being operable to:
control communication between said supervisor workstation and said at least one user workstation; and
control said data recording means and said data storage means.

3. The data processing and communication system of claim 2, further comprising at least one additional supervisor workstation connected to the communication network, wherein said server is further operable to automatically switch said connection between said at least one user workstation and said supervisor workstation to one of said at least one additional supervisor workstation in response to one of:
termination of said connection between said at least one user workstation and said one of said supervisor workstation; and
an instruction received from said supervisor requesting switch of said connection.

4. The data processing and communication system of claim 1, wherein the communication network is selected at least from the following group: local area network (LAN), wide area network (WAN), Internet, Intranet, dial-up network, and wireless network.

5. The data processing and communication system of claim 1, wherein said user data comprises media data, comprising at least one of audio and visual data, representative of a user's physical activities at said at least one user workstation.

6. The data processing and communication system of claim 5, further comprising task program means, at said at least one user workstation, for enabling the user to perform a predetermined task at said at least one user workstation, wherein said user data further comprises task data representative of results of the user's performance of said predetermined task.

7. The data processing and communication system of claim 6, wherein said predetermined task is at least one of: a question and answer examination, an adaptive test examination, a multimedia question and answer set, a skill and proficiency test, resolution of a technical support issue, and an interview.

8. The data processing and communication system of claim 6, further comprising security means for at least one of: concealing said task data from said supervisor when said task data is confidential, and removing said task program means from said at least one user workstation when said predetermined task is completed by the user.

9. The data processing and communication system of claim 1, wherein said data acquisition means comprises a camera operable to acquire a visual image stream of the user and of an area surrounding said at least one user workstation.

10. The data processing and communication system of claim 9, wherein said camera is operable to move within a predetermined field of view, and wherein said supervisor workstation further comprises first control means for controlling said motion of said camera in response to said supervisor's instructions.

11. The data processing and communication system of claim 9, wherein said data acquisition means further comprises a microphone operable to acquire an audio data stream from the user and from said area surrounding said at least one user workstation.

12. The data processing and communication system of claim 11, further comprising data control means, at said supervisor workstation, for controlling, by said supervisor, parameters of at least one of said visual image stream and audio data stream.

13. The data processing and communication system of claim 6, further comprising lockout means for preventing the user from utilizing unauthorized program applications and hardware components at said at least one user workstation during performance of said predetermined task by the user.

14. The data processing and communication system of claim 6, further comprising system monitoring means for detecting an attempt by the user to utilize unauthorized program applications and hardware components at said at least one user workstation during performance of said predetermined task by the user.

15. The data processing and communication system of claim 14, further comprising termination means at said supervisor workstation for terminating the user's performance of said predetermined task prior to completion thereof when unauthorized activity by the user is detected by said supervisor via at least one of said data acquisition means and said system monitoring means, and for recording said termination action in said session record.

16. The data processing and communication system of claim 1, further comprising communication means for communication between the user and said supervisor during user's performance of said predetermined task.

17. The data processing and communication system of claim 1, wherein said communication means comprises a chat application executed by at least one of said supervisor workstation and said at least one user workstation.

18. The data processing and communication system of claim 1, wherein said data transmission means comprises synchronized multi-media data streaming based at said at least one user workstation to facilitate data transmission over a low-bandwidth connection.

19. The data processing and communication system of claim 1, wherein each said at least one user workstation comprises authentication means for verifying identity of a user utilizing said at least one user workstation by acquiring authentication data.

20. The data processing and communication system of claim 1, wherein said authentication means comprises at least one of: a biometric scanner, a password supplied by the user, and an image of the user's photographic personal identification acquired by said data acquisition means.

21. The data processing and communication system of claim 19, further comprising means for storing said authentication data in said session record.

22. The data processing and communication system of claim 1, further comprising:
second data acquisition means, located at said supervisor workstation, for capturing supervisor data representative of at least a portion of activities of a supervisor at said supervisor workstation;
second data transmission means for transmitting said supervisor data to said at least one user workstation for viewing by a user.

23. The data processing and communication system of claim 22, further comprising instruction means for enabling shared application access from said supervisor workstation with said at least one user workstation.

24. The data processing and communication system of claim 6, wherein said supervisor workstation further comprises display means for displaying said user data to said supervisor.

25. The data processing and communication system of claim 24, wherein said display means comprise a display monitor, and wherein said supervisor workstation comprises a first graphical front-end interface operable for display on said display monitor to said supervisor, said first graphical front-end interface comprising:
at least one user monitor window operable to:
display said visual user data received from said at least one user workstation,
provide information representative of parameters of said user data to said supervisor, and
enable said supervisor to control said parameters
a task window operable to display non-visual user data received from said at least one user workstation; and
at least one of: a chat window for enabling chat communication between said supervisor workstation and said at least one user workstation, a hotkey message window for selectively sending one of a plurality of predefined test messages to said at least one user workstation, and a hotkey control window for providing customizable functional controls over said supervisor workstation to said supervisor.

26. The data processing and communication system of claim 24, wherein said display means comprise a plurality of display monitors, and wherein said supervisor workstation comprises a second graphical front-end interface operable for display on said plural display monitors to said supervisor, said second graphical front-end interface comprising:
a program front end interface, positioned at a first plural display monitor, comprising a task window operable to display non-visual user data received from said at least one user workstation; and at least one of: a chat window for enabling chat communication between said supervisor workstation and said at least one user workstation, a hotkey message window for selectively sending one of a plurality of predefined test messages to said at least one user workstation, and a hotkey control window for providing customizable functional controls over said supervisor workstation to said supervisor.
a plurality of user monitor windows positioned at other plural display monitors, each of said plural user monitor windows being operable to:
display said visual user data received from a plurality of corresponding user workstations,
provide information representative of parameters of said user data from each said plural user workstation to said supervisor, and
enable said supervisor to control said parameters.

27. A data processing and communication system for at least one of: administrating, monitoring, verifying and authenticating remote activities of a plurality of users over a communication network, comprising:
a plurality of user workstations, each utilized by the corresponding plural user, connected to the communication network,
a plurality of supervisor workstations, each utilized by a corresponding supervisor, connected to the communication network;
at least one server connected to the communication network operable to operable to: in response to a request by a particular plural user, determine an available plural supervisor workstation, connect said corresponding plural user workstation to said available plural supervisor workstation, and monitor communication therebetween;
data acquisition means, located at each said plural user workstation, for capturing user data representative of activities of the corresponding plural user;
data transmission means for transmitting said user data from each said plural user workstation to said connected plural supervisor workstation such that said plural supervisor can monitor said plural user data in real-time;
data recording means, at said at least one server, for recording said plural user data in a session record; and
data storage means, at said at least one server, for storing said session record for future authentication of performance of the plural user activities and the plural user identity.

28. A data processing and communication method for at least one of administrating, monitoring, and authenticating remote user activities over a communication network, comprising the steps of:
(a) providing at least one user workstation connected to the communication network,
(b) providing a supervisor workstation connected to the communication network;
(c) capturing user data representative of activities of the remote user at each said at least one user workstation;
(d) transmitting said user data to said supervisor workstation such that a supervisor can monitor said user data;
(e) recording said user data in a session record; and
(f) storing said session record for future authentication of performance of said remote user activities and the user identity.

29. The data processing and communication method of claim 28, further comprising the steps of:
(g) providing at least one server connected to the communication network
(h) providing at least one additional supervisor workstation connected to the communication network; and
(i) automatically switching, by said at least one server, said connection between said at least one user workstation and said supervisor workstation to one of said at least one additional supervisor workstation in response to one of:
termination of said connection between said at least one user workstation and said one of said supervisor workstation; and
an instruction received from said supervisor requesting switch of said connection.

30. The data processing and communication method of claim 28, wherein the communication network is selected at least from the following group: local area network (LAN), wide area network (WAN), Internet, Intranet, dial-up network, and wireless network.

31. The data processing and communication method of claim 28, wherein said user data comprises media data, comprising at least one of audio and visual data, representative of a user's physical activities at said at least one user workstation.

32. The data processing and communication method of claim 31, further comprising the step of:
(j) providing a task application to enable the user to perform a predetermined task at said at least one user workstation, wherein said user data further comprises task data representative of results of the user's performance of said predetermined task.

33. The data processing and communication method of claim 32, wherein said predetermined task is at least one of: a question and answer examination, an adaptive test examination, a multimedia question and answer set, a skill and proficiency test, resolution of a technical support issue, and an interview.

34. The data processing and communication method of claim 32, further comprising the steps of:
(k) concealing said task data from said supervisor when said task data is confidential; and
(l) removing said task application from said at least one user workstation when said predetermined task is completed by the user.

35. The data processing and communication method of claim 32, further comprising the step of:
(m) preventing the user from utilizing unauthorized program applications and hardware components at said at least one user workstation during performance of said predetermined task by the user.

36. The data processing and communication method of claim 32, further comprising the step of:
(n) detecting an attempt by the user to utilize unauthorized program applications and hardware components at said at least one user workstation during performance of said predetermined task by the user.

37. The data processing and communication method of claim 36, further comprising the steps of:
(o) terminating, by said supervisor, the user's performance of said predetermined task prior to completion thereof when unauthorized activity by the user is detected by said supervisor, and
(p) recording said termination action in said session record.

38. The data processing and communication method of claim 28, further comprising the step of:
(q) providing selective communication between the user and said supervisor during user's performance of said predetermined task.

39. The data processing and communication method of claim 28, further comprising the step of:
(r) verifying identity of a user by acquiring authentication data; and
(s) storing said authentication data in said session record.
